(19) United States
(12) Patent Application Publication
(10) Pub. No.: US 2002/0083597 A1
(43) Pub. Date: Jul. 4, 2002

(54) Material cutting device for making crafts

(76) Inventor: Jane G. Garner, Kaysville, UT (US)

Correspondence Address: Kaardal & Associates, PC, Attn: Ivar M. Kaardal, Suite 250, 3500 South First Ave. Circle, Sioux Falls, SD, 57105-5802, US

(21) Appl. No.: 09/751,738

(22) Filed: Dec. 29, 2000

(51) Int. Cl. B26B 3/00

(52) U.S. Cl. 30/316

(57) ABSTRACT

A material cutting device for making crafts for providing a means of cutting pieces of paper and fabric to form various crafts. The material cutting device for making crafts includes an endless band-like body member having a definite width and also having a top edge and a bottom edge which is adapted to cut through materials such as fabric and paper; and also includes a hand support member being securely attached along the top edge of the endless band-like body member.

### BACKGROUND OF THE INVENTION

1. Field of the Invention

The present invention relates to a craft cutting device and more particularly pertains to a new material cutting device for making crafts for providing a means of cutting pieces of paper and fabric to form various crafts.

2. Description of the Prior Art

The use of a craft cutting device is known in the prior art. More specifically, a craft cutting device heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. Nos. 5,864,909; 5,579,582; 4,424,601; 4,789,555; 2,249,399; U.S. Pat. No. Des. 282,893; and U.S. Pat. No. 3,456,346.

While these devices fulfill their respective, particular objectives and requirements, the aforementioned patents do not disclose a new material cutting device for making crafts. The inventive device includes an endless band-like body member having a definite width and also having a top edge and a bottom edge which is adapted to cut through materials such as fabric and paper; and also includes a hand support member being securely attached along the top edge of the endless band-like body member.

In these respects, the material cutting device for making crafts according to the present invention substantially departs from the conventional concepts and designs of the prior art, and in so doing provides an apparatus primarily developed for the purpose of providing a means of cutting pieces of paper and fabric to form various crafts.

### SUMMARY OF THE INVENTION

In view of the foregoing disadvantages inherent in the known types of craft cutting device now present in the prior art, the present invention provides a new material cutting device for making crafts construction wherein the same can be utilized for providing a means of cutting pieces of paper and fabric to form various crafts.

The general purpose of the present invention, which will be described subsequently in greater detail, is to provide a new material cutting device for making crafts which has many of the advantages of the craft cutting device mentioned heretofore and many novel features that result in a new material cutting device for making crafts which is not anticipated, rendered obvious, suggested, or even implied by any of the prior art craft cutting device, either alone or in any combination thereof.

To attain this, the present invention generally comprises an endless band-like body member having a definite width and also having a top edge and a bottom edge which is adapted to cut through materials such as fabric and paper; and also includes a hand support member being securely attached along the top edge of the endless band-like body member.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new material cutting device for making crafts which has many of the advantages of the craft cutting device mentioned heretofore and many novel features that result in a new material cutting device for making crafts which is not anticipated, rendered obvious, suggested, or even implied by any of the prior art craft cutting device, either alone or in any combination thereof.

It is another object of the present invention to provide a new material cutting device for making crafts which may be easily and efficiently manufactured and marketed.

It is a further object of the present invention to provide a new material cutting device for making crafts which is of a durable and reliable construction.

An even further object of the present invention is to provide a new material cutting device for making crafts which is susceptible of a low cost of manufacture with regard to both materials and labor, and which accordingly is then susceptible of low prices of sale to the consuming public, thereby making such material cutting device for making crafts economically available to the buying public.

Still yet another object of the present invention is to provide a new material cutting device for making crafts which provides in the apparatuses and methods of the prior art some of the advantages thereof, while simultaneously overcoming some of the disadvantages normally associated therewith.

Still another object of the present invention is to provide a new material cutting device for making crafts for providing a means of cutting pieces of paper and fabric to form various crafts.

Yet another object of the present invention is to provide a new material cutting device for making crafts which includes an endless band-like body member having a definite width and also having a top edge and a bottom edge which is adapted to cut through materials such as fabric and paper; and also includes a hand support member being securely attached along the top edge of the endless band-like body member.

Still yet another object of the present invention is to provide a new material cutting device for making crafts that would function as easy as a cookie cutter by cutting patterns in paper and fabric materials.

Even still another object of the present invention is to provide a new material cutting device for making crafts that is easy and convenient to use and simplifies the task of making crafts.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a new material cutting device for making crafts according to the present invention.

FIG. 2 is a side elevational view of the present invention.

FIG. 3 is a cross-sectional view of the present invention.

### DESCRIPTION OF THE PREFERRED EMBODIMENT

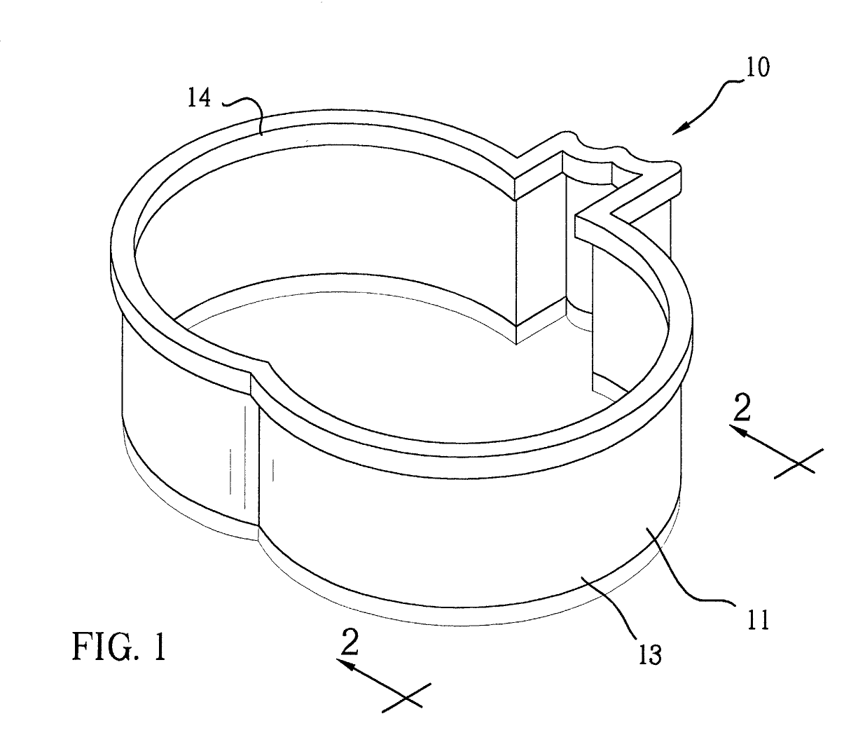

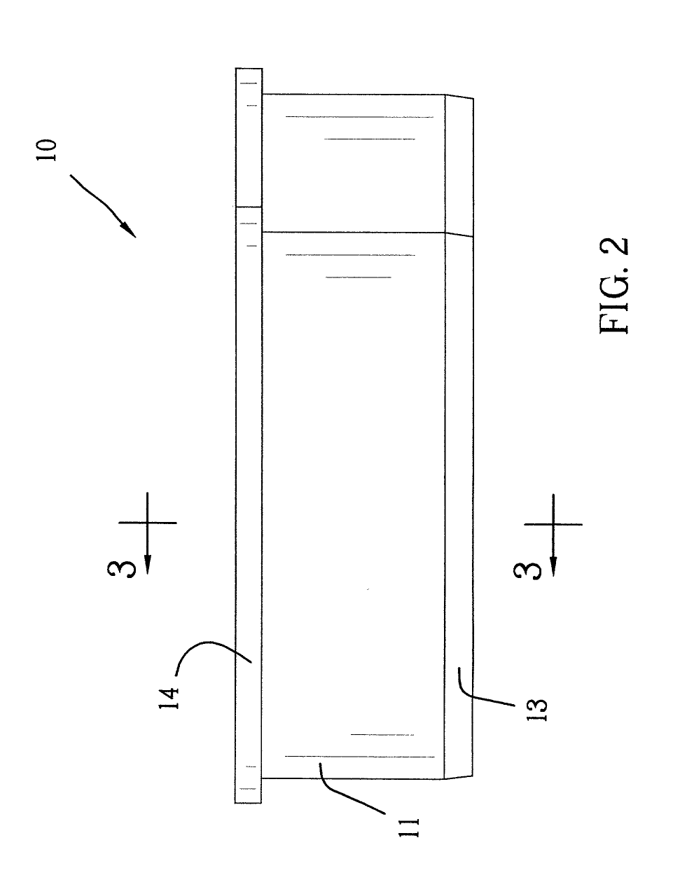

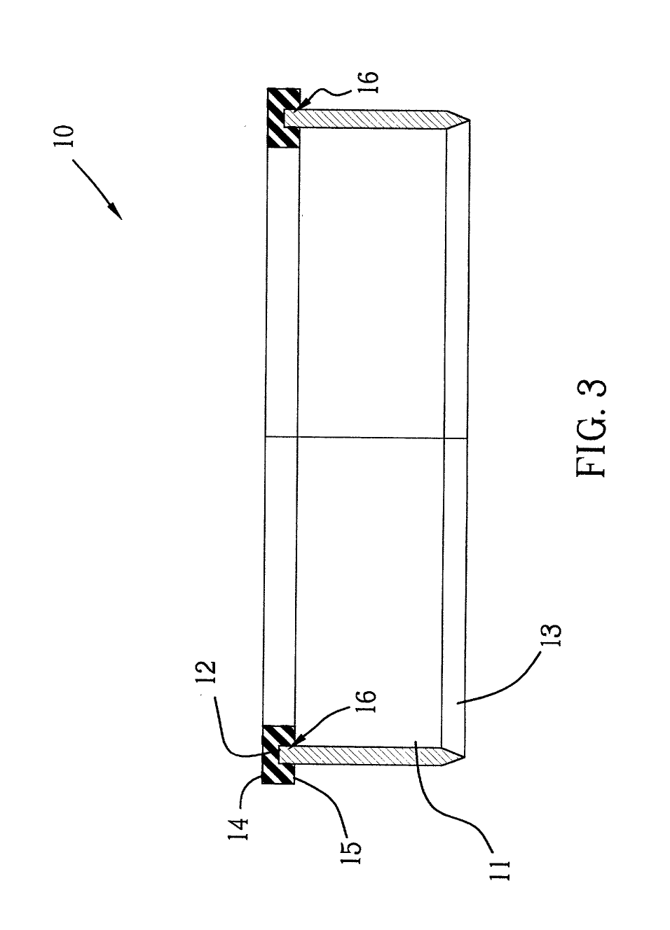

With reference now to the drawings, and in particular to FIGS. 1 through 3 thereof, a new material cutting device for making crafts embodying the principles and concepts of the present invention and generally designated by the reference numeral 10 will be described.

As best illustrated in FIGS. 1 through 3, the material cutting device for making crafts 10 generally comprises an endless band-like body member 11 having a definite width and also having a top edge 12 and a bottom edge 13 which is adapted to cut through materials such as fabric and paper. The bottom edge 13 of the endless band-like member 11 being generally a blade which is adapted to cut through the materials such as fabric and paper. The endless band-like body member 11 has a plurality of shapes as viewed from either above or below the endless band-like body member 11. The shapes include circles, squares, triangles, pumpkins, turkey, trees, Santa Claus, rabbits, hearts, stars, letters of the alphabet, and numbers with the endless band-like body member 11 being generally made of a thin strip of metal having a definite thickness.

A hand support member 14 is securely and removably attached along the top edge 12 of the endless band-like body member 11. The hand support member 14 is generally an endless band having a greater thickness than that of the endless band-like body member 11. The endless band member 14 has a bottom side 15 and an endless groove 16 centrally disposed in the bottom side 15 with the groove 16 being adapted to receive the top edge 12 of the endless band-like body member 11. The endless band member 14 extends outwardly from either side of the endless band-like body member 11 with the endless band member 14 being generally made of a rubberized material.

In use, the user places the bottom edge 13 of the endless band-like body member 11 upon a piece of uniform material such as paper or fabric and places one's hand upon the hand support member 14 and presses firmly upon the top of the endless band-like body member 11 to cut through the material in the shape of the endless band-like body member 11 for use in making various crafts.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A material cutting device for making crafts comprising:
an endless band-like body member having a definite width and also having a top edge and a bottom edge which is adapted to cut through materials such as fabric and paper; and
a hand support member being securely attached along said top edge of said endless band-like body member.

2. A material cutting device for making crafts as described in claim 1, wherein said bottom edge of said endless band-like member is generally a blade which is adapted to cut through the materials such as fabric and paper.

3. A material cutting device for making crafts as described in claim 2, wherein said endless band-like body member has a plurality of shapes as viewed either from above or from below said endless band-like body member, said shaped including circles, squares, triangles, pumpkins, turkey, trees, Santa Claus, rabbits, hearts, stars, letters of the alphabet, and numbers.

4. A material cutting device for making crafts as described in claim 3, wherein said endless band-like body member is generally made of a thin strip of metal.

5. A material cutting device for making crafts as described in claim 1, wherein said hand support member is generally an endless band having a greater thickness than that of said endless band-like body member.

6. A material cutting device for making crafts as described in claim 5, wherein said endless band member has a bottom side and an endless groove centrally disposed in said bottom side, said groove being adapted to receive said top edge of said endless band-like body member, said endless band member extending outwardly from either side of said endless band-like body member.

7. A material cutting device for making crafts as described in claim 6, wherein said endless band member is generally made of a rubberized material.

8. A material cutting device for making crafts comprising:
an endless band-like body member having a definite width and also having a top edge and a bottom edge which is adapted to cut through materials such as fabric and paper, said bottom edge of said endless band-like member being generally a blade which is adapted to cut through the materials such as fabric and paper, said endless band-like body member having a plurality of shapes as viewed from either above or below said endless band-like body member, said shaped including circles, squares, triangles, pumpkins, turkey, trees, Santa Claus, rabbits, hearts, stars, letters of the alphabet, and numbers, said endless band-like body member being generally made of a thin strip of metal; and
a hand support member being securely attached along said top edge of said endless band-like body member, said hand support member being generally an endless band having a greater thickness than that of said endless band-like body member, said endless band member having a bottom side and an endless groove centrally disposed in said bottom side, said groove being adapted to receive said top edge of said endless band-like body member, said endless band member extending outwardly from either side of said endless band-like body member, said endless band member being generally made of a rubberized material.
